(19) United States
(12) Patent Application Publication
(10) Pub. No.: US 2003/0025449 A1
(43) Pub. Date: Feb. 6, 2003

(54) Hybrid LED

(75) Inventor: Wolfgang Rossner, Holzkirchen (DE)

Correspondence Address: FRISHAUF, HOLTZ, GOODMAN & CHICK, PC, 767 THIRD AVENUE, 25TH FLOOR, NEW YORK, NY, 10017-2023, US

(73) Assignee: Osram Opto Semiconductors GmbH, Regensburg (DE)

(21) Appl. No.: 10/186,574

(22) Filed: Jul. 1, 2002

(30) Foreign Application Priority Data
Aug. 3, 2001 (DE) 10137641.3

(51) Int. Cl. H01J 1/62

(52) U.S. Cl. 313/512

(57) ABSTRACT

Hybrid LED having a radiation-emitting semiconductor body (chip) which is surrounded by a housing which comprises at least a base body and a cap, the chip being seated in a recess of the base body, and the primary radiation of the chip being converted at least partially into longer wave radiation by a conversion means. The cap is formed by a glass-like body, the conversion means being contained in the glass-like body.

### TECHNICAL FIELD

The invention proceeds from a hybrid LED having a radiation-emitting semiconductor body (chip), which is connected to electric terminals and surrounded by a housing which comprises at least one base body and a cap, the chip being seated on the base body, in particular in a recess of the base body, and the primary radiation of the chip being converted by a conversion element at least partially into longer wave radiation. In particular, it relates to the hybrid LED which generates white light and has a UV-resistant glass conversion element.

### BACKGROUND ART

U.S. Pat. No. 5,966,393 has already disclosed a hybrid LED in the case of which a part of the housing can be produced from glass. A conversion of the primary emitted light is provided here by thin films or layers on the LED chip. In a similar way, U.S. Pat. No. 2,001,045,573 also describes a primary UV-emitting LED, in the case of which a part of the housing can consist of glass. The conversion is performed here by thin layers on surfaces of the separate housing.

### DISCLOSURE OF THE INVENTION

It is the object of the present invention to provide a hybrid LED having a radiation-emitting semiconductor body (chip), which is connected to electric terminals and surrounded by a housing which comprises at least one base body and a cap, the chip being seated on the base body, in particular in a recess of the base body, and the primary radiation of the chip being converted by a conversion element at least partially into longer wave radiation, said hybrid LED being particularly compact and easy to construct. A further object is to provide an LED which is resistant to the emitted UV radiation and has a high optical outcoupling efficiency.

This object is achieved by the following means: the cap is formed by a glass-like body, the conversion means being contained in the glass-like body.

A luminescence conversion LED (Lucoled) is based mostly on an LED chip whose primary emission is in the UV or short wave blue spectral region (300 to approximately 460 nm). This radiation is subsequently entirely or partially converted by a conversion element (mostly a luminescent material) into longer wave radiation.

It is therefore possible to generate either very stable colored LEDs, or else to utilize mixing effects such as, for example, the production of white light. This comes about through suitable mixing of individual luminescent materials and/or suitable tuning of the intensity of primary and secondary light. It is therefore possible, in particular on the basis of an LED emission with a blue primary emission, to produce lucoleds with defined color spectra, for example complex mixed colors (magenta) and white light according to the principle of additive color mixing. The luminescent materials are frequently organic dye molecules or inorganic pigment powders. They are mostly embedded in a sealing compound.

In the case of chips with UV or short-wave blue emission, in particular in the region from 300 to 430 nm peak emission, a particularly severe problem arises that the known sealing compound (to date epoxy resin) is not sufficiently stable against this short-wave radiation. After lengthy irradiation, a permanent discoloration of the sealing compound occurs, and this leads to degradation of the optical transmission which disadvantageously influences both the luminous intensity and the spectral emission characteristics of the lucoleds.

Previous solutions, as outlined above, are complicated or dependent on special conditions.

According to the invention, a hybrid design is now claimed in the case of which the sealing compound is replaced by an element (glass-like cap) which consists of an inorganic glass and itself contains the conversion means.

In detail, the hybrid LED is provided with a radiation-emitting semiconductor body which can, in particular, be an InGaN chip. The chip is connected to electric terminals, for example it is fastened on an electrically conducting lead frame and surrounded by a housing. The latter comprises at least a base body and a cap, the chip being seated on the base body, in particular in a recess of the base body. To optimize the optical outcoupling efficiency of the primary radiation, the conversion element (in particular a cap) is connected with the aid of a UV-resistant silicone-based optical coupling gel directly to the radiation-emitting semiconductor body (what is termed n-matching). The primary radiation of the chip is converted at least partially into longer wave radiation by a conversion element.

A partial conversion is appropriate whenever the primary radiation is in the visible spectral region, that is to say for a peak wavelength of at least 440 nm. A complete conversion is to be recommended in the case of a primary radiation with a wavelength of at most 430 nm, since this cannot be used in the visible spectral region.

According to the invention, the cap is formed by a glass-like body, the conversion means being contained in the glass-like body. The glass-like body is formed from glass, glass ceramic or quartz glass. It is preferred to make use of silicate and borate glasses, it being possible to configure the glass composition such that they are adapted to the chemical behavior and the thermal expansion response of the luminescent materials and of the LED construction materials. The glass-like body should be transparent to the primary emitted radiation.

Normally, in this case the conversion element is a luminescent material which is dispersed in the glass-like body. The dispersion can either be homogeneous or be concentrated on specific regions, in particular when the outcoupling and conversion elements are optimized. A further embodiment is a hybrid LED in the case of which the glass-like body is directly a luminescing glass, the conversion means being formed by constituents of the luminescing glass. Particularly suitable as luminescent materials are what are termed inorganic intercalation luminescent materials. Suitable for this purpose, for example, are luminescent materials such as are described in U.S. Pat. No. 5,531,926 and U.S. Pat. No. 5,674,430. Particularly suitable in concrete terms is one of the rare earth garnet types of luminescent material (for example YAG:Ce), thiogallate or else chlorosilicate. A suitable type of luminescent glass is presented in EP-A 338 934.

Glasses or other glass-like bodies are generally inert to UV radiation. Since the processing temperature of glasses is far above 300° C. as a rule, it is not possible for a direct fusion with the chip itself or the structure containing the chip to occur. It is advisable to provide a recess on the glass body or on the base body for the chip. The chip is preferably arranged in a recess of the base body which can additionally take over the function of a reflector. The electric terminals can also be fixed in the base body. The cap and the base body can be joined by plugging, clamping, bonding or welding, and be connected permanently in a gas-tight fashion. In this case, in particular, the recess (generally a cavity between chip and cap) can be filled with a UV-stable optical medium of high refractive index (above 1.4, in particular 1.4 to 1.5) for the purpose of better optical coupling. A silicone composition or optical grease may be given as examples. A particular advantage is that this design permits the use of non-curable optical coupling media, in particular of liquids.

The production of the glass body can be performed by mixing a glass frit (in powder form) with the suitable proportion of luminescent material powder (or mixtures of pulverulent luminescent materials). Subsequently, the glass mix is melted, then cast and pressed.

The glass body can be shaped in this case so as to achieve desired optical effects with reference to light propagation. For example, it can have the shape of a lens or be configured as a Fresnel lens system. The surfaces of the glass body can, moreover, be coated with reflector layers, antireflection layers, etc. in order to achieve optimum light outcoupling and homogeneous light distribution. The luminescent pigment can either be distributed homogeneously, or be applied at special locations in the glass body.

In principle, the glass body can also be a glass ceramic in the case of which a crystalline phase results after production of the glass body by a thermal treatment. This phase can also constitute the luminescent material.

Furthermore, the glass of the glass body can itself take over the luminescence conversion when a luminescent glass is used. It is then possible to dispense entirely or partially with the use of separate luminescent pigments.

### BRIEF DESCRIPTION OF THE DRAWINGS

The invention is to be explained in more detail below with the aid of a plurality of exemplary embodiments.

In the drawing:

FIG. 1 shows a luminescence conversion LED, in section, and

FIG. 2 shows a further exemplary embodiment of a luminescence conversion LED.

### BEST MODE FOR CARRYING OUT THE INVENTION

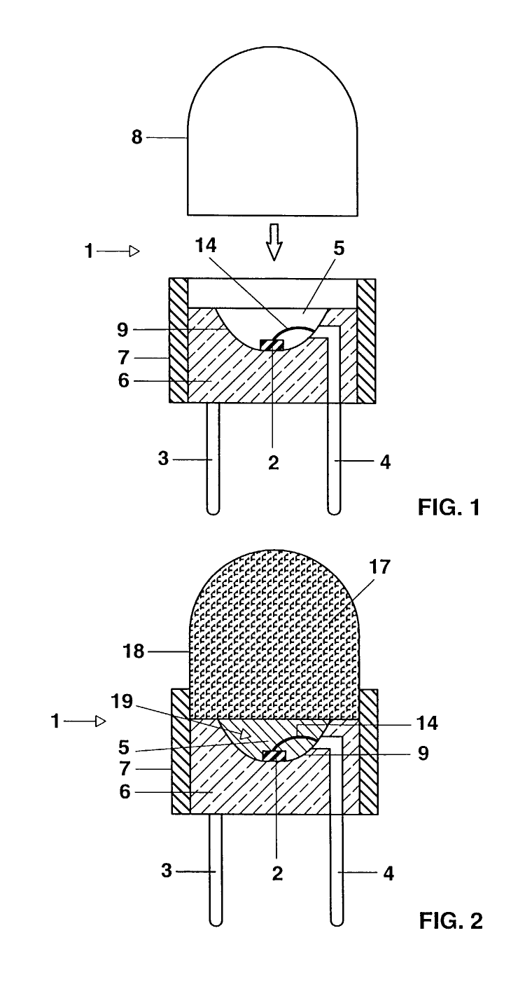

A luminescence conversion LED 1 is shown in FIG. 1. The core is the chip 2, which emits primary UV radiation and is connected to electric terminals 3, 4. One of the latter is connected to the chip via a bond wire 14. The chip 2 is seated in the recess 5 of a base body 6, for example made from plastic. The wall of the recess is shaped as a reflector 9. The base body 6 is surrounded by side walls 7. Mounted on the base body 6 is a lens-shaped cap 8. It is connected to the base body 6 permanently or by an adhesive. The cap 8 is made from a luminescent glass. The latter converts the primary radiation, emitted in the UV (at a peak wavelength of 400 nm) completely (or else partially) into longer wave visible radiation. In one variant, it is a glass with a specific emission peak such that the emission appears colored. A further embodiment is a mixture of two or more glasses that are selected such that the entire emission appears white.

A further, particularly preferred exemplary embodiment is shown in FIG. 2. The same components are denoted by the same reference numerals. By contrast with the first exemplary embodiment, use is made here of a cap 18 that consists of glass in which one or more luminescent materials 17 is/are dispersed homogeneously as pigment. Moreover, the recess 5 is filled with an optical coupling medium 19. In one variant, this is a luminescent material with a specific emission peak such that the emission appears colored. A further embodiment relates to a mixture of two or more luminescent materials that are selected such that the entire emission appears white.

The cap 18 has optical properties, in particular it can have an optical Fresnel lens, a bifocal lens, a plano-convex or a plano-concave lens.

What is claimed is:

1. A hybrid LED which comprises:
a radiation-emitting semiconductor body (chip), which is connected to electric terminals and surrounded by a housing which comprises at least one base body and a cap, the chip being seated on the base body, in particular in a recess of the base body, and the primary radiation of the chip being converted by a conversion element at least partially into longer wave radiation,
and wherein said cap is formed by a glass-like body, the conversion means being contained in the glass-like body.

2. The hybrid LED as claimed in claim 1, wherein the glass-like body is formed from glass or glass ceramic.

3. The hybrid LED as claimed in claim 1, wherein the conversion means is a luminescent material which is dispersed into the body.

4. The hybrid LED as claimed in claim 1, wherein the conversion means is formed by constituents of a luminescent glass.

5. The hybrid LED as claimed in claim 3, wherein the luminescent material is formed by what is termed an inorganic intercalation luminescent material.

6. The hybrid LED as claimed in claim 1, wherein the recess is filled with an optically transparent medium with a high refractive index.

7. The hybrid LED as claimed in claim 1, wherein the cap has optical properties, in particular a Fresnel lens system, a bifocal lens, a plano-convex or plano-concave lens.
